(19) United States
(12) Patent Application Publication
(10) Pub. No.: US 2025/0355956 A1
(43) Pub. Date: Nov. 20, 2025

(54) PAIRWISE COMPARISON RATING TO REDUCE PRESENTATION BIAS IN CONTENT RECOMMENDATION

(71) Applicant: Roku, Inc., San Jose, CA (US)

(72) Inventors: Fei XIAO, San Jose, CA (US); Amit Verma, Sunnyvale, CA (US); Rohit Mahto, San Jose, CA (US); Lian Liu, Rancho Palos Verdes, CA (US); Ronica Jethwa, Mountain View, CA (US); Jose Sanchez, San Jose, CA (US); Nam Vo, San Jose, CA (US); Atishay Jain, San Bruno, CA (US); Pulkit Aggarwal, San Jose, CA (US); Abhishek Bambha, Burlingame, CA (US); Daniel Meropol, Brooklyn, NY (US); Rameen Mahdavi, San Jose, CA (US); Aasish Sipani, Danville, CA (US)

(73) Assignee: Roku, Inc., San Jose, CA (US)

(21) Appl. No.: 18/667,192

(22) Filed: May 17, 2024

(51) Int. Cl. G06F 16/9538; G06F 16/2457; G06F 16/9535

(52) U.S. Cl. CPC G06F 16/9538; G06F 16/24578; G06F 16/9535

(57) ABSTRACT

Disclosed herein are system, apparatus, article of manufacture, method and/or computer program product embodiments, and/or combinations and sub-combinations thereof, for pairwise comparison rating to reduce presentation bias in content recommendation. An embodiment operates by generating respective ranking values for a plurality of content items based on interactions between user devices and the content items. The respective ranking value for each content item is adjusted based on additional interactions between the user devices and the content items compared to predicted interactions between the user devices and content items. When a first user device of the plurality of user devices requests content, pairwise distances between the respective ranking values for the content items and respective weighted values for historical content items that have been previously interacted with by the first user device are determined. The first user device displays a first content item based on the associated pairwise distance being the shortest pairwise distance.

### FIELD

This disclosure is generally directed to content management, and more particularly to pairwise comparison rating to reduce presentation bias in content recommendation.

### SUMMARY

Provided herein are system, apparatus, article of manufacture, method and/or computer program product embodiments, and/or combinations and sub-combinations thereof, for pairwise comparison rating to reduce presentation bias in content recommendation. An example embodiment operates by generating respective ranking values for a plurality of content items based on interactions between the devices and the content items. The respective ranking value for each content item is adjusted based on additional interactions between the user devices and the content items compared to predicted interactions between the user devices and content items derived from the respective ranking values. When a first user device of the plurality of user devices requests content, pairwise distances between the respective ranking values for the content items and respective weighted values for historical content items that have been previously interacted with by the first user device are determined. The first user device displays a first content item based on the pairwise distance between the respective ranking value for the first content item and the respective weighted value for a first historical content item being the shortest pairwise distance.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates an example system for generating a weighted value representative of a personalized Elo rating-based rank for pairwise comparison rating to reduce presentation bias in content recommendation, according to some embodiments.

FIG. 4 illustrates a flowchart of an example method for pairwise comparison rating to reduce presentation bias in content recommendation, according to some embodiments.

FIG. 5 illustrates a flowchart of an example method for pairwise comparison rating to reduce presentation bias in content recommendation, according to some embodiments.

FIG. 6 illustrates an example computer system useful for implementing various embodiments.

In the drawings, like reference numbers generally indicate identical or similar elements. Additionally, generally, the leftmost digit(s) of a reference number identifies the drawing in which the reference number first appears.

### DETAILED DESCRIPTION

Provided herein are system, apparatus, device, method, and/or computer program product embodiments, and/or combinations and sub-combinations thereof, for pairwise comparison rating to reduce presentation bias in content recommendation.

Various metrics associated with content request and delivery, for example, content item popularity, relevancy, and/or the like may be used to present user devices (e.g., mobile devices, set-top boxes, content playback devices, media devices, etc.) with content items. Particularly, content delivery systems employ various algorithms to predict what information a user and/or user device may request and/or have an interest in based on historical content consumption behavior, preferences, search history, and other personalized data. A user device requesting content may be presented with the most popular content items and/or content items most relevant to the request (e.g., based on various query parameters, etc.). However, the matter of which content items are deemed the most popular (and thus the most relevant) may be subject to filter bubbling and/or suffer from a positive feedback loop where a content item predicted to be popular or relevant is presented to more users/user devices for playback and/or responsive to queries and therefore are repeatedly predicted as the most popular or relevant for subsequent queries. As described herein, user-specific filtering based on pairwise comparison of content items may be used to avoid such content bias and/or presentation bias.

One or more machine learning models trained for custom Elo rating-based ranking may use content interaction data (e.g., impression data, telemetry data, and/or the like) for/from multiple user devices to generate ranking values (e.g., Elo popularity scores, etc.) for content items. The ranking values for the content items may be further adjusted and/or refined according to the viewer/interaction history of a specific user/user device to generate weighted values (e.g., personalized Elo rating-based scores, etc.). The weighted values may be used to present content items to the user/user device as the result of a query and/or the like without bias.

To address content bias and/or presentation bias associated with content delivery and/or presentation example content items, assuming a user device playback and/or consumption of example content item 1, a deep learning model may sample pairs of example content item 1 and an example content item 2. A ranking value (Elo popularity score, etc.) for example content item 1 may be increased and the ranking value for example content item 2 may be adjusted accordingly. According to some aspects of this disclosure, through pairwise comparison rating to reduce presentation bias in content recommendation, a ranking value (Elo popularity score, etc.) may be dependent on how well content items compare to others instead of how many times a content item has been displayed (e.g., an impression, etc.) or interacted with by a user device.

A content item impression in a content recommendation and/or content delivery system refers to each time a content item including, but not limited to, an article, video, advertisement, or any digital media, is displayed to (or interacted by) a user and/or user device. An impression metric provides insight regarding the visibility and reach of content items within a system. Conventional content recommendation and/or content delivery systems are unable to avoid content item presentation bias. As described herein, a machine learning model may evaluate and compare content items that receive impression in a similar manner as a chess game, where the rating/ranking of a winning content item is increased and the rating/ranking of a losing content item is reduced. New popularity ranking values (e.g., Elo popularity scores, etc.) and weighted values (e.g., personalized Elo rating-based scores, etc.) based personalization may be based on pairwise comparison of content items to reduce presentation bias generated by conventional models. Therefore, based on the pairwise comparison rating to reduce presentation bias in content recommendation, as described herein, the popularity ranking of a content item may no longer be artificially inflated by presentation bias that is promoted by the number of plays or total streaming by a user device where more time a content item is presented in the Home screen of the user device, the more the content item will be presented to the user device as popular.

As described herein, usage of pairwise comparison rating to reduce presentation bias in content recommendation not only resolves content bias and/or presentation bias but also assists in resolving cold start issues associated with newer content items where there is a challenge to effectively recommend or deliver the new content items because they lack prior interaction data or history. Particularly, new content items are compared directly with existing content items when generating content item recommendations and/or query results instead of needing to gain significant amounts of impressions/interactions to increase their popularity. These and other technological advantages are described herein.

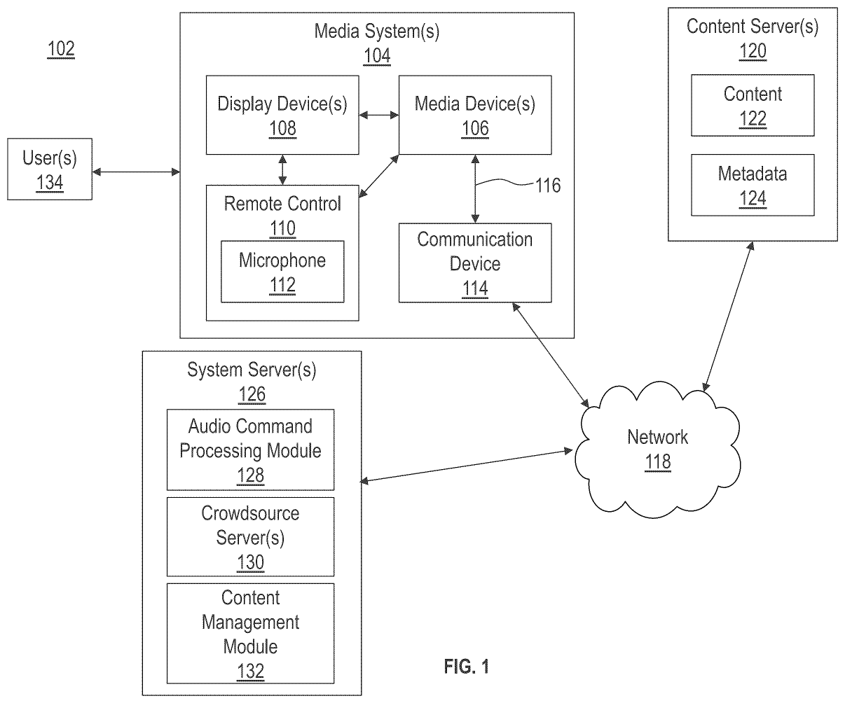

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method, and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 134 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smartphone, tablet, wearable (such as a watch or glasses), appliance, Internet of Things (IoT) device, and/or projector, to name just a few examples. In some embodiments, media device 106 can be a part of, integrated with, operatively coupled to, and/or connected to its respective display device 108.

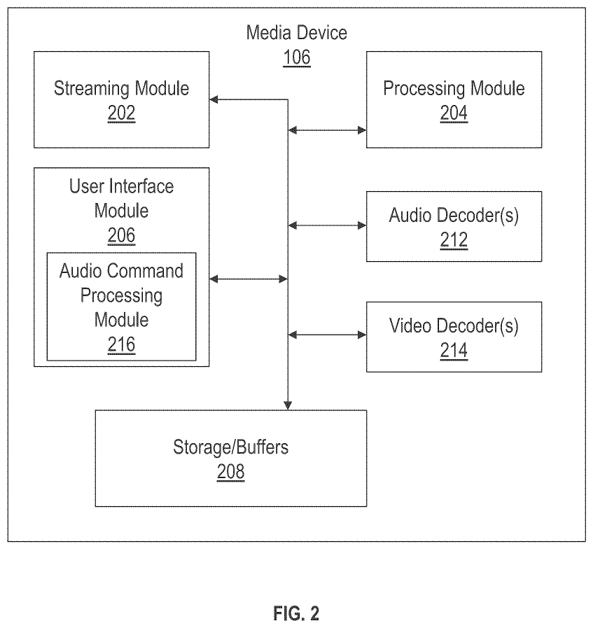

FIG. 2 illustrates a block diagram of an example media device 106, according to some embodiments. The media device 106 may include a streaming module 202, processing module 204, storage/buffers 208, and a user interface module 206. The user interface module 206 may include an audio command processing module 216.

The media device 106 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples. Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Returning to FIG. 1, each media device 106 may be configured to communicate with network 118 via a communication device 114. The communication device 114 may include, for example, a cable modem or satellite TV transceiver. The media device 106 may communicate with the communication device 114 over link 116, wherein link 116 may include wireless (such as WiFi) and/or wired connections.

In various embodiments, the network 118 can include, without limitation, wired and/or wireless intranet, extranet, Internet, cellular, Bluetooth, infrared, and/or any other short-range, long-range, local, regional, global communications mechanism, means, approach, protocol and/or network, as well as any combination(s) thereof.

Media system 104 may include a remote control 110. The remote control 110 can be any component, part, apparatus, and/or method for controlling the media device 106 and/or display device 108, such as a remote control, a tablet, laptop computer, smartphone, wearable, on-screen controls, integrated control buttons, audio controls, or any combination thereof, to name just a few examples. According to some aspects of this disclosure, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels, or sources). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of content items, music, videos, movies, TV programs, multimedia, images, still pictures, text, graphics, gaming applications, advertisements, programming content, public service content, government content, local community content, software, and/or any other content and/or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, objects depicted in content and/or content items, object types, closed captioning data/information, audio description data/information, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system server(s) 126. The system server(s) 126 may operate to support the media devices 106 from the cloud. It is noted that the structural and functional aspects of the system server(s) 126 may wholly or partially exist in the same or different ones of the system server(s) 126.

The system server(s) 126 may include an audio command processing module 128. As noted above, the remote control 110 may include a microphone 112. The microphone 112 may receive audio data from users 134 (as well as other sources, such as the display device 108). In some embodiments, the media device 106 may be audio responsive, and the audio data may represent verbal commands from the user 134 to control the media device 106 as well as other components in the media system 104, such as the display device 108.

In some embodiments, the audio data received by the microphone 112 in the remote control 110 is transferred to the media device 106, which is then forwarded to the audio command processing module 128 in the system server(s) 126. The audio command processing module 128 may operate to process and analyze the received audio data to recognize the user 134's verbal command. The audio command processing module 128 may then forward the verbal command back to the media device 106 for processing.

In some embodiments, the audio data may be alternatively or additionally processed and analyzed by an audio command processing module 216 in the media device 106 (see FIG. 2). The media device 106 and the system server(s) 126 may then cooperate to pick one of the verbal commands to process (either the verbal command recognized by the audio command processing module 128 in the system server(s) 126, or the verbal command recognized by the audio command processing module 216 in the media device 106).

Now referring to both FIGS. 1 and 2, in some embodiments, the user 134 may interact with the media device 106 via, for example, the remote control 110. For example, user 134 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 134.

In streaming embodiments, the streaming module 202 may transmit the content to the display device 108 in real-time or near real-time as it receives such content from the content server(s) 120. In non-streaming embodiments, the media device 106 may store the content received from content server(s) 120 in storage/buffers 208 for later playback on display device 108.

According to some aspects of this disclosure, the media devices 106 may exist in thousands or millions of media systems 104. Accordingly, the media devices 106 may lend themselves to crowdsourcing embodiments and, thus, the system server(s) 126 may include one or more crowdsource server(s) 130.

According to some aspects of this disclosure, using information received from the media devices 106 in the thousands and millions of media systems 104, the crowdsource server(s) 130 may identify similarities and overlaps between closed captioning requests issued by different users 134 watching a particular movie. Based on such information, the crowdsource server(s) 130 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 130 may operate to cause closed captioning to be automatically turned on and/or off during future streaming of the movie.

According to some aspects of this disclosure, using information received from the media devices 106 in the thousands and millions of media systems 104, the crowdsource server(s) 130 may identify popular content and/or content items. For example, the most popular content and/or content items may be determined based on the amount of content and/or content items are displayed/viewed (e.g., impressions, etc.), requested (e.g., viewed, accessed, etc.), and/or interacted with by media devices 106. The crowdsource server(s) 130 may identify similarities, such as common attributes, features, elements, and or the like, between content and/or content items. The crowdsource server(s) 130 may provide a content management module 132 information indicative of and/or used to identify similarities, such as common attributes, features, elements, and or the like, between content and/or content items.

According to some aspects of this disclosure, the content management module 132 may include one or more machine learning models (e.g., deep learning models, predictive models, neural networks, etc.) trained for Elo rating-based ranking of content items. One or more machine learning models may use content interaction data for multiple user devices to generate ranking values (e.g., Elo popularity scores, etc.) for content items. The ranking values for the content items may be further adjusted and/or refined according to the viewer/interaction history of a specific user/user device to generate weighted values (e.g., personalized Elo rating-based scores, etc.). The weighted values may be used to present content items to the user/user device as the result of a query and/or the like without bias.

### Pairwise Comparison Rating To Reduce Presentation Bias In Content Recommendation

According to some aspects of this disclosure, at least one method for pairwise comparison rating to reduce presentation bias in content recommendation may be performed by sampling pairs of content items that, according to interaction data, have impressed for the same user device in the same session, where a first content item has playback of more than 10 minutes and a second content item does not. Ranking values (e.g., Elo popularity scores, etc.) for the first and second content items may be adjusted such that the ranking value for the first content item is increased and the ranking value for the second content item is reduced. According to some aspects of this disclosure, ranking values for each of a plurality of content items may be determined through similar pairwise competitions of the content items impressed by each of a plurality of user devices.

According to some aspects of this disclosure, a deep neural network may be specifically trained to predict ranking values for content items based on the features (e.g., content-based features, etc.) of the content items. According to some aspects of this disclosure, a Siamese neural network and/or the like may be trained to generate personalized weighted values (e.g., personalized Elo-based scores/rankings, etc.) unique to a user device playback and/or content item interaction session based on user preferences, historical playback data, and/or the like associated with the user device. For example, the Siamese neural network may predict interactions (e.g., content items playback events, content item playback satisfying a threshold (more than 10 minutes), etc.).

To train the Siamese neural network, training data may be collected for pair content items A and B where content items A and B are in the same session and impressed and a user device plays content item A instead of content item B. According to some aspects of this disclosure, the probability of the user device playback of content item A instead of B can be calculated using the following logistic function where the exponent term is defined by the ranking values (e.g., Elo popularity scores, etc.) of content item A and content item B:

$$\frac{1}{1 + {e}^{( - ( Elo ranking ( content item A ) - Elo ranking ( content item B )}}$$

The output of the above function can be interpreted as the probability that content item A is “more popular” than content item B, based on their ranking values. After training the Siamese neural network with personalized play data, the Siamese neural network may use user device-specific features to predict and output personalized weighted values (e.g., personalized Elo-based scores/rankings, etc.) useful for personalized content item ranking and presentation bias avoidance.

Referring to FIG. 1, as described, the content management module 132 may include one or more trained machine learning models that utilize interaction and/or impression data along with Elo rating and analysis to generate ranking values for content items that represent a disposition and/or classification of content items, for example, popularity, relevance, and/or the like, with regards to multiple users (e.g., a plurality of user devices, etc.).

For example, to utilize Elo rating-based ranking to identify popular content items in a content delivery and/or recommendation system, a machine learning model of the content management module 132 may consider each interaction between a user (e.g., user 134, etc.) and/or a user device (e.g., media device 106, display device 108, smart device, mobile device, set-top box, content playback device, etc.) and a content item as a “match” where the outcome reflects the content item's appeal to the user/user device. Content items may be assigned an initial Elo rating-based ranking value that represents a current property and/or classification of the content item including, but not limited to, popularity, relevance, quality level, and/or the like. According to some aspects, as a common starting point, each content item may be assigned the same ranking value.

Competitive interactions, for example, competitive matches and/or the like, between content items may be used to adjust assigned ranking values. In the context of content item popularity, a “win” or “loss” can be determined by user interactions. For example, a machine learning model of the content management module 132 may consider playback of a content item, selection of a content item, dwell time for a content item, and/or the like to be a win for a content item when the content item is played back, interacted with, selected, and/or the like over other content items. No playback, selection, dwell time, and/or the like for a content item may be considered a loss for the content item when the content item is not played back, interacted with, selected, and/or the like in comparison to other content items. After each interaction, the machine learning model of content management module 132 may adjust the ranking value of content items based on the outcome of the interaction.

The adjustment may depend on an outcome forecasted by the machine learning model versus the actual outcome. For example, if a content item with a lower ranking value (e.g., a less popular content item, etc.) receives a positive interaction (e.g., playback, selection, dwell, etc.), the ranking value of the content item may be increased more than a content item with a higher ranking value (e.g., a more popular content item, etc.) for the same interaction. A predicted/forecasted ranking value for a content item in a match (interaction) may be determined using analysis including, but not limited to, logical regression, decision tree analysis, random forests analysis, support vector machines, Bayesian techniques, and/or the like. According to some aspects of this disclosure, for uniformity, the content management module 132 may receive initial ranking values from the crowdsource server(s) 130 (and/or a third-party source), and the content management module 132 may use the same ranking scales and values for content items presented to different segments of users/user devices (e.g., by geographic location, device type, or content preference). According to some aspects of this disclosure, to adapt ranking values to various user bases, the content management module 132 may receive different interaction data from different crowdsource server(s) 130 (and/or a third-party sources) and maintain separate ranking scales and values for content items based on different segments of users/user devices (e.g., by geographic location, device type, or content preference).

According to some aspects of this disclosure, the content management module 132 may include one or more trained machine learning models that utilize ranking values for content items and user-specific historical data (e.g., content item interaction data, impression data, viewership data, user preferences, etc.) to customize content item recommendation, presentation, and/or delivery for a user (e.g., user 134, etc.) and/or a user device (e.g., media device 106, display device 108, smart device, mobile device, set-top box, content playback device, etc.). The machine learning model may forecast/predict the outcome of a “match” between a user/user device and a content item based on the current ranking value for the content item, user-specific historical data, and/or user-specific features (e.g., user demographics, user preferences, etc.).

According to some aspects of this disclosure, the machine learning model may be trained on a large dataset of user-specific data. The dataset may include labeled features that include, but are not limited to, content item rankling values, user/user device historical rating patterns, and content item classifications (e.g., genre, parental guidance ratings, etc.). The dataset may be provided to the machine learning model, such as a deep learning model, and an optimization algorithm may be used to adjust the parameters of the machine learning model to minimize the difference between the predicted outputs and the true outputs.

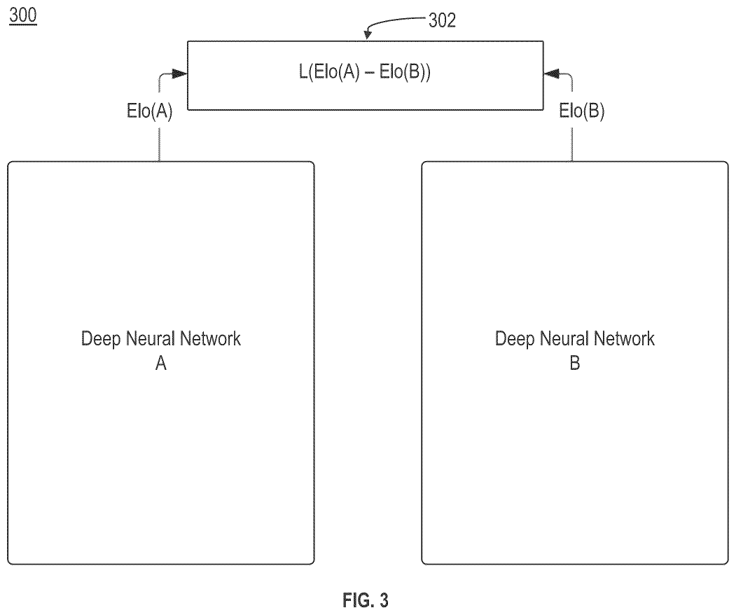

The machine learning model may employ any architecture. For example, as shown in FIG. 3, a machine learning model of the content management module 132 may be a Siamese neural network 300 to generate personalized weighted values (e.g., personalized Elo-based scores/rankings, etc.) for user-specific content filtering, particularly pairwise comparison rating to reduce presentation bias in content recommendation. Siamese neural network 300 may include two identical subnetworks, deep neural network A and deep neural network B, that share the same weights and architecture. Siamese network 300 could be trained on embeddings and/or representations of content items based on the labeled features of the dataset previously described. The embeddings may then be used to calculate the similarity between user/user device and content item pairs, enabling personalized content delivery and/or recommendation.

Deep neural network A and deep neural network B may both share content item ranking values and weights as inputs and predict/generate personalized weighted values (e.g., personalized Elo-based scores/rankings.) for (user, content item) pair, with user/user device features and content item features. Deep neural network A and deep neural network B may both output a weighted value for user/user device and content item pairs according to an Elo rating analysis of the user-specific historic data and the content item.

For example, according to some aspects of this disclosure, a loss function 302 may be a cross-entropy loss with a label equal to “1” if a content item (A) is played more than 10 minutes by a specific user/user device and content item (B) is not played (or played less than 10 minutes) when content items A and B are shown/presented together to the user/user device. The loss function 302 may be a cross-entropy loss with a label equal to “0” if the content item (B) is played for more than 10 minutes and content item (A) is not played (or played for less than 10 minutes).

As described, the weighted values (e.g., personalized Elo-based scores/rankings, etc.) of content items may be used as features for content management module 132 to predict content popularity for a specific content item and recommend the content item to a specific user/user device. Therefore, the weighted values for content items provide a dynamic and continually updated measure of content popularity (or any other desired/intended classification/rating, etc.) that reflects user/user device behavior and preferences.

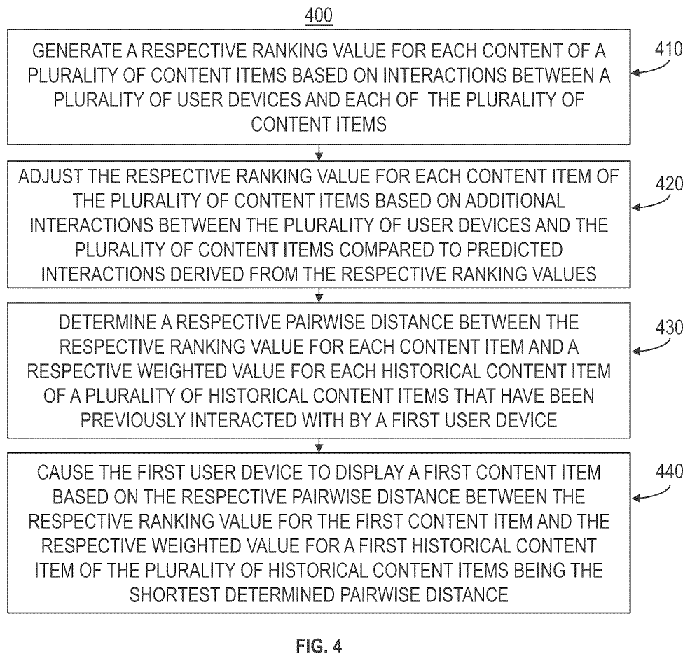

FIG. 4 shows a flowchart of an example method 400 for pairwise comparison rating to reduce presentation bias in content recommendation, according to some aspects of this disclosure. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1-3. However, method 400 is not limited to the aspects of those figures. A computer-based system (e.g., the multimedia environment 102, the system server(s) 126, content management module 132, etc.) may facilitate pairwise comparison rating to reduce presentation bias in content recommendation.

In 410, system server(s) 126 generates a respective ranking value for each content of the plurality of content items. System server(s) 126 may generate the respective ranking value for each content of the plurality of content items based on interaction data indicative of interactions between a plurality of user devices and each content item of a plurality of content items. According to some aspects of this disclosure, the respective ranking value for each content of the plurality of content items may represent the popularity of the content item, engagement with the content item, recent playback of the content item, a recent query result for the content item, and/or the like.

In 420, system server(s) 126 adjusts the respective ranking value for each content item of the plurality of content items. System server(s) 126 may adjust the respective ranking value for each content item of the plurality of content items based on additional interactions between the plurality of user devices and each content item of a plurality of content items compared to predicted interactions between the plurality of user devices and each content item of the plurality of content items. The predicted interactions may be derived from the ranking values for the plurality of content items.

In 430, system server(s) 126 determines a respective pairwise distance between the respective ranking value for the content item and a respective weighted value for each historical content item of a plurality of historical content items that have been previously interacted with by the first user device. System server(s) 126 may determine the respective pairwise distance between the respective ranking value for the content item and the respective weighted value for each historical content item of the plurality of historical content items based on a request for content by a first user device of the plurality of user devices.

According to some aspects of this disclosure, the respective weighted value for each historical content item of the plurality of historical content items may be determined based on historical interactions between the first user device and each content item of the plurality of historical content items compared to predicted interactions between the first user device and each content item of the plurality of historical content items. For example, the respective weighted value for each historical content item of the plurality of historical content items may be increased or decreased relative to how closely the predicted interaction with the historical content item matches an actual interaction with the historical content item.

In 440, system server(s) 126 causes the first user device to display the first content item of the plurality of content items. System server(s) 126 may cause the first user device to display the first content item based on the respective pairwise distance between the respective ranking value for the first content item and the respective weighted value for the first historical content item of the plurality of historical content items being a shortest determined pairwise distance.

According to some aspects of this disclosure, causing the first user device to display the first content item may include causing the first user device to display a second content item with a ranking value below a threshold that indicates relevance to the first user device. According to some aspects of this disclosure, the method 400 may further include system server(s) 126 adjusting the ranking value for the second content item to satisfy the threshold. System server(s) 126 may adjust the ranking value for the second content item to satisfy the threshold based on an indication from the first user device of a selection of the second content item over the first content item. System server(s) 126 may send the second content item to the first user device.

According to some aspects of this disclosure, causing the first user device to display the first content item may include causing the first user device to display a second content item with a ranking value that satisfies a threshold that indicates relevance to the first user device. According to some aspects of this disclosure, the method 400 may further include system server(s) 126 adjusting the ranking value for the second content item to below the threshold. System server(s) 126 may adjust the ranking value for the second content item to below the threshold based on an indication from the first user device of a selection of the first content item over the second content item. System server(s) 126 may send the first content item to the first user device.

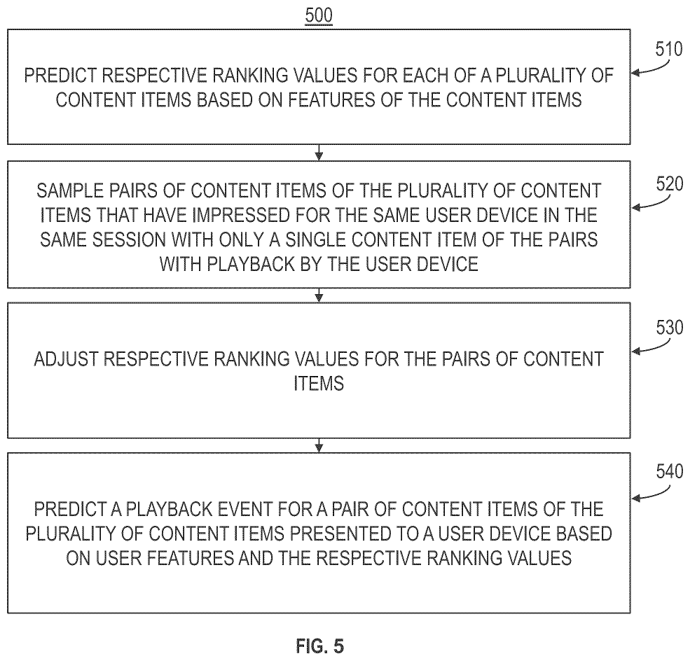

FIG. 5 shows a flowchart of an example method 500 for pairwise comparison rating to reduce presentation bias in content recommendation, according to some aspects of this disclosure. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIGS. 1-3. However, method 500 is not limited to the aspects of those figures. A computer-based system (e.g., the multimedia environment 102, the system server(s) 126, content management module 132, etc.) may facilitate pairwise comparison rating to reduce presentation bias in content recommendation.

According to some aspects of this disclosure, content items may be ranked according to popularity. For example, a ranking value (e.g., an Elo-based popularity score, etc.) may be used to indicate popularity of a content item. Weighted values (e.g., Elo-based personalized score, etc.) may be assigned to content items to represent the user-specific popularity of the content items. Content items may be ranked according to an Elo-based score for each (user, content item) pair. For example, for each user (A), content items may be ranked according to score Elo (A, I), where I is the content item.

In 510, system server(s) 126 predicts ranking values (e.g., Elo-based popularity scores, etc.) for each of a plurality of content items based on the features (most content based features) of the content items.

In 520, system server(s) 126 samples pairs of content items that have impressed for the same user device 134 in the same session, where one content item (content item A) has playback for a threshold duration (e.g., playback of more than 10 minutes, etc.), and another content item (content item B) does not.

In 530, system server(s) 126 adjusts the ranking values of content items that have impressed for the same user device 134 in the same session. For example, system server(s) 126 can increase the ranking value for the content item (content item A) with a playback of more than 10 minutes, and reduce the ranking value for the content item (content item B) with a playback of less than 10 minutes.

In 540, system server(s) 126 predicts a playback event for a pair of content items of the plurality of content items presented to a user device based on user features and the respective ranking values. For example, to generate weighted values (e.g., personalized Elo-based scores/rankings, etc.), system server(s) 126 can use user features to predict a playback event for user device 134.

To predict playback events, system server(s) 126 may be trained on data collected for pairs of content items (e.g., content item A and content item B) that are in the same session, impressed, and one content item of the pair is selected over the other (e.g., playback of content item A instead of content item B, etc.). According to some aspects of this disclosure, the probability of playback of content item A instead of B by user device 134 may be calculated using the following logistic function where the exponent term is defined by the ranking values (e.g., Elo popularity scores, etc.) of content item A and content item B:

$$\frac{1}{1 + {e}^{( - ( Elo ranking ( content item A ) - Elo ranking ( content item B )}}$$

The output of the above function can be interpreted as the probability that content item A is “more popular” than content item B, based on their ranking values. After training system server(s) 126 with personalized play data, system server(s) 126 may use user device-specific features to predict and output personalized weighted values (e.g., personalized Elo-based scores/rankings, etc.) useful for personalized content item ranking and presentation bias avoidance.

### Example Computer System

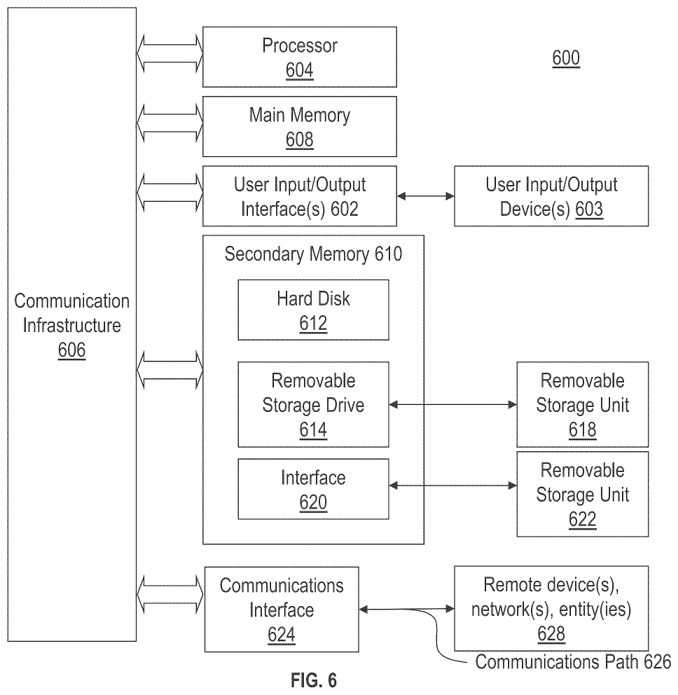

Various embodiments may be implemented, for example, using one or more well-known computer systems, such as computer system 600 shown in FIG. 6. For example, the media device 106 may be implemented using combinations or sub-combinations of computer system 600. Also or alternatively, one or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, a tape backup device, and/or any other storage device/drive.

Removable storage drive 614 may interact with a removable storage unit 618. Removable storage unit 618 may include a computer-usable or readable storage device having stored thereon computer software (control logic) and/or data. Removable storage unit 618 may be a floppy disk, magnetic tape, compact disk, DVD, optical storage disk, and/or any other computer data storage device. Removable storage drive 614 may read from and/or write to removable storage unit 618.

Secondary memory 610 may include other means, devices, components, instrumentalities, or other approaches for allowing computer programs and/or other instructions and/or data to be accessed by computer system 600. Such means, devices, components, instrumentalities, or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smartphone, smartwatch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600 or processor(s) 604), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 6. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expressions “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A computer-implemented method of pairwise comparison rating to reduce presentation bias in content recommendation, comprising:
generating, by at least one computer processor of a content delivery system, a respective ranking value for each content item of a plurality of content items based on interaction data indicative of interactions between a plurality of user devices and each content item of the plurality of content items;
adjusting the respective ranking value for each content item of the plurality of content items based on additional interactions between the plurality of user devices and each content item of the plurality of content items compared to predicted interactions between the plurality of user devices and each content item of the plurality of content items, wherein the predicted interactions are derived from the respective ranking values for the plurality of content items;
in response to a request for content by a first user device of the plurality of user devices, determining a respective pairwise distance between the respective ranking value for each content item of the plurality of content items and a respective weighted value for each historical content item of a plurality of historical content items that have been previously interacted with by the first user device, wherein the respective pairwise distance between the respective ranking value for each content item of the plurality of content items and the respective weighted value for each historical content item of a plurality of historical content items is output by a trained model, and wherein training the model comprises:
sampling pairs of content items that have impressed for a same user device in a same session, wherein a first content item of a pair of content items has playback of more than a threshold duration and a second content item of the pair of content items does not have playback of more than the threshold duration; and
causing the first user device to display a first content item of the plurality of content items based on the respective pairwise distance between the respective ranking value for the first content item and the respective weighted value for a first historical content item of the plurality of historical content items being a shortest determined pairwise distance.

2. The computer-implemented method of claim 1, wherein the respective ranking value for each content item of the plurality of content items represents at least one of popularity of the respective content item, engagement with the respective content item, or relevance of the respective content item.

3. The computer-implemented method of claim 1, wherein the respective weighted value for each historical content item of the plurality of historical content items is determined based on historical interactions between the first user device and each content item of the plurality of historical content items compared to predicted interactions between the first user device and each content item of the plurality of historical content items.

4. The computer-implemented method of claim 1, wherein the causing the first user device to display the first content item further comprises causing the first user device to display a second content item with a ranking value below a threshold that indicates relevance to the first user device, and the method further comprising:
adjusting, based on an indication from the first user device of a selection of the second content item over the first content item, the ranking value for the second content item to satisfy the threshold; and
sending the second content item to the first user device.

5. The computer-implemented method of claim 1, wherein the causing the first user device to display the first content item further comprises causing the first user device to display a second content item with a ranking value that satisfies a threshold that indicates relevance to the first user device, and the method further comprising:
adjusting, based on an indication from the first user device of a selection of the first content item over the second content item, the ranking value for the second content item to below the threshold; and
sending the first content item to the first user device.

6. The computer-implemented method of claim 1, wherein the respective pairwise distance between the respective ranking value for each content item of the plurality of content items and the respective weighted value for each historical content item of a plurality of historical content items is output by a Siamese neural network pre-trained for Elo rating-based analysis of content items.

7. The computer-implemented method of claim 1, wherein the plurality of user devices comprises at least one of smart devices, content playback devices, or set-top boxes.

8. A system for pairwise comparison rating to reduce presentation bias in content recommendation, comprising:
one or more memories;
at least one processor each coupled to at least one of the memories and configured to perform operations comprising:
generating a respective ranking value for each content item of a plurality of content items based on interaction data indicative of interactions between a plurality of user devices and each content item of the plurality of content items;
adjusting the respective ranking value for each content item of the plurality of content items based on additional interactions between the plurality of user devices and each content item of the plurality of content items compared to predicted interactions between the plurality of user devices and each content item of the plurality of content items, wherein the predicted interactions are derived from the respective ranking values for the plurality of content items;
in response to a request for content by a first user device of the plurality of user devices, determining a respective pairwise distance between the respective ranking value for each content item of the plurality of content items and a respective weighted value for each historical content item of a plurality of historical content items that have been previously interacted with by the first user device, wherein the respective pairwise distance between the respective ranking value for each content item of the plurality of content items and the respective weighted value for each historical content item of a plurality of historical content items is output by a trained model, and wherein training the model comprises:
sampling pairs of content items that have impressed for a same user device in a same session, wherein a first content item of a pair of content items has playback of more than a threshold duration and a second content item of the pair of content items does not have playback of more than the threshold duration; and
causing the first user device to display a first content item of the plurality of content items based on the respective pairwise distance between the respective ranking value for the first content item and the respective weighted value for a first historical content item of the plurality of historical content items being a shortest determined pairwise distance.

9. The system of claim 8, wherein the respective ranking value for each content item of the plurality of content items represents at least one of popularity of the respective content item, engagement with the respective content item, or relevance of the respective content item.

10. The system of claim 8, wherein the respective weighted value for each historical content item of the plurality of historical content items is determined based on historical interactions between the first user device and each content item of the plurality of historical content items compared to predicted interactions between the first user device and each content item of the plurality of historical content items.

11. The system of claim 8, wherein the causing the first user device to display the first content item further comprises causing the first user device to display a second content item with a ranking value below a threshold that indicates relevance to the first user device, and the operations further comprising:
adjusting, based on an indication from the first user device of a selection of the second content item over the first content item, the ranking value for the second content item to satisfy the threshold; and
sending the second content item to the first user device.

12. The system of claim 8, wherein the causing the first user device to display the first content item further comprises causing the first user device to display a second content item with a ranking value that satisfies a threshold that indicates relevance to the first user device, and the operations further comprising:
adjusting, based on an indication from the first user device of a selection of the first content item over the second content item, the ranking value for the second content item to below the threshold; and
sending the first content item to the first user device.

13. The system of claim 8, wherein the respective pairwise distance between the respective ranking value for each content item of the plurality of content items and the respective weighted value for each historical content item of a plurality of historical content items is output by a Siamese neural network pre-trained for Elo rating-based analysis of content items.

14. The system of claim 8, wherein the plurality of user devices comprises at least one of smart devices, content playback devices, or set-top boxes.

15. A non-transitory computer-readable medium having instructions stored thereon that, when executed by at least one computing device, cause the at least one computing device to perform operations for pairwise comparison rating to reduce presentation bias in content recommendation, the operations comprising:
generating a respective ranking value for each content item of a plurality of content items based on interaction data indicative of interactions between a plurality of user devices and each content item of the plurality of content items;
adjusting the respective ranking value for each content item of the plurality of content items based on additional interactions between the plurality of user devices and each content item of the plurality of content items compared to predicted interactions between the plurality of user devices and each content item of the plurality of content items, wherein the predicted interactions are derived from the respective ranking values for the plurality of content items;
in response to a request for content by a first user device of the plurality of user devices, determining a respective pairwise distance between the respective ranking value for each content item of the plurality of content items and a respective weighted value for each historical content item of a plurality of historical content items that have been previously interacted with by the first user device, wherein the respective pairwise distance between the respective ranking value for each content item of the plurality of content items and the respective weighted value for each historical content item of a plurality of historical content items is output by a trained model, and wherein training the model comprises:
sampling pairs of content items that have impressed for a same user device in a same session, wherein a first content item of a pair of content items has playback of more than a threshold duration and a second content item of the pair of content items does not have playback of more than the threshold duration; and
causing the first user device to display a first content item of the plurality of content items based on the respective pairwise distance between the respective ranking value for the first content item and the respective weighted value for a first historical content item of the plurality of historical content items being a shortest determined pairwise distance.

16. The non-transitory computer-readable medium of claim 15, wherein the respective ranking value for each content item of the plurality of content items represents at least one of popularity of the respective content item, engagement with the respective content item, or relevance of the respective content item.

17. The non-transitory computer-readable medium of claim 15, wherein the respective weighted value for each historical content item of the plurality of historical content items is determined based on historical interactions between the first user device and each content item of the plurality of historical content items compared to predicted interactions between the first user device and each content item of the plurality of historical content items.

18. The non-transitory computer-readable medium of claim 15, wherein the causing the first user device to display the first content item further comprises causing the first user device to display a second content item with a ranking value below a threshold that indicates relevance to the first user device, and the operations further comprising:
adjusting, based on an indication from the first user device of a selection of the second content item over the first content item, the ranking value for the second content item to satisfy the threshold; and
sending the second content item to the first user device.

19. (canceled)

20. The non-transitory computer-readable medium of claim 15, wherein the causing the first user device to display the first content item further comprises causing the first user device to display a second content item with a ranking value that satisfies a threshold that indicates relevance to the first user device, and the operations further comprising:
adjusting, based on an indication from the first user device of a selection of the first content item over the second content item, the ranking value for the second content item to below the threshold; and
sending the first content item to the first user device.
